(19) United States
(12) Patent Application Publication
(10) Pub. No.: US 2018/0253566 A1
(43) Pub. Date: Sep. 6, 2018

(54) SECURE SYSTEM FOR EXCHANGING SENSITIVE INFORMATION OVER A NETWORK

(71) Applicant: Bilal Soylu, Sanford, NC (US)

(72) Inventor: Bilal Soylu, Sanford, NC (US)

(21) Appl. No.: 15/852,783

(22) Filed: Dec. 22, 2017

Related U.S. Application Data
(60) Provisional application No. 62/467,523, filed on Mar. 6, 2017.

(51) Int. Cl. G06F 21/62; H04L 9/08; H04L 29/06; G06F 3/0482

(52) U.S. Cl. CPC G06F 21/6245; H04L 9/083; G06F 3/0482; H04L 63/108; H04L 63/0442

(57) ABSTRACT

A secure system, method, apparatus, and computer program product for exchanging sensitive information over a computing network. The system allows a user to receive and review an information request from a requestor, such as a business, on the network. If the user approves of the information request, a local memory storage of the user's computing device is searched to determine if any requested information items are resident in the local memory storage. If the system determines that one or more requested information items are not resident in storage, the user is prompted for one or more missing data items. Once the user has entered the missing data items, the user may then review the data submission, before being transmitted to the information requester. The user may also assign a usage policy to the data submission. An encryption key may be used to encrypt the data submission.

### CROSS-REFERENCE TO RELATED APPLICATION

This application claims the benefit of priority of U.S. provisional application Ser. No. 62/467,523, filed Mar. 6, 2017, the contents of which are herein incorporated by reference.

### BACKGROUND OF THE INVENTION

The present invention relates to the exchange of electronic data on a network, and more particularly to a system for securely exchanging sensitive information over a network.

Entities (companies and consumers) have an increased need to exchange electronic data that contains sensitive information such as privacy related specific identifications, including Names, DOBs, Address, SSN etc. Current mechanisms are difficult and cumbersome to use. Every exchange is conducted differently and most obfuscate the use of the exchanged data. Security and error risks exist in form of employee data keying and scanning and data handling. Furthermore, the time needed to collect and process the information reduces participation by consumers.

Current systems on the market are addressing the problem from the perspective of the business (information-requestor). They are inherently less transparent to use for users (data-owner), exposing the users' to data leakage and error risks. Every business interaction is different (point-to-point) and there is no overall tracking of all such exchanges. Many times, employees are involved in verification steps. Users cannot describe their desired data use policy and are asked repetitively for the same data by information-requestor's employees and affiliated different business entities. This does not serve the customer's interest. In addition, if sensitive information is collected on paper forms, the processing times, exposure risk, and error rates are increased.

Previously, to provide sensitive data, consumers had to either walk through a series of business provided systems with difficult to determine data-use policies or when working directly with staff, expose themselves to potential data and identity theft. Other forms, such as exchanging data on paper forms, adds increased time and handling errors to this while also adding disposal cost to business. Previous systems are essentially point-to-point mechanisms where every exchange works differently. Under existing systems, consumers and businesses cannot transfer learning derived from one data-interaction to the next. Moreover, for the consumer, there is no means available to monitor post transactional use and security of their data by the business.

As can be seen, there is a need for an improved system, method and apparatus that provides a unified system and methodology that addresses the need of both the business (information-requestor) and the consumer (data-owner) while providing transparency to catch misuse of exchanged information after a data exchange.

### SUMMARY OF THE INVENTION

In one aspect of the present invention, a computer-readable memory is adapted for use by a user of a data sharing client application to exchange sensitive data over a network. The computer-readable memory used to direct a computer on the network to perform the steps of: receiving a data request from an information requester on the network platform. The data request may seek one or more requested information items from the user of the data-owner. The requested information items are presented on a display of data-owner's computer. One or more corresponding data items matching the one or more requested information items are automatically retrieved from a local storage of the computer. A determination is made as to whether the corresponding data items satisfy all of the requested information items. In preferred embodiments, the corresponding data items are stored in an encrypted form on the local storage device.

If the corresponding data items do not satisfy all of the requested information items, the user is prompted to input one or more missing information items that are not contained within the local storage. The user input of the one or more missing information items is received and the corresponding data items and the one or more missing information items are presented on a display of the computing device. A data submission, responsive to the one or more requested information items, is then transmitted to the information requester.

If the corresponding data items satisfy all of the requested information items, the corresponding data items are presented on a display of the computing device. A data submission of the corresponding data items is then transmitted to the information requester via the network platform.

In some embodiments, the user may also assign a usage policy to the data submission, before transmitting the data submission to the information requester. The usage policy may apply one or more usage constraints on the requester's use of the data submission. The usage constraints may include a temporal duration and/or a number of uses.

In other aspects of the invention, an encryption key may be retrieved from a server operatively coupled to the network. All data on the client computer is encrypted with asymmetric keys. The local encryption is performed after the public key is retrieved from the network. The data submission may be encrypted with another information-requestor specific encryption key. The computer readable media may be configured to receive a confirmation that the data submission has been received by the information requester. The information request may be selected from the group consisting of a URL, a QR code, a barcode, and a request file.

Other embodiments of the invention include a computerized system for use by a user of a data sharing client application to exchange sensitive data over a network platform. The system includes a computer having a user interface; and a program product comprising machine-readable program code for causing, when executed, the computer to perform process steps. The steps may include receiving a data request from an information requester on the network platform. The data request may seek one or more requested information items from the data-owner. The requested information are stored in encrypted for on the data-owner's computer. The data-owner's computer makes a request for appropriate decryption keys from the network and decrypted items are provided on a display of the computer. One or more corresponding data items matching the one or more requested information items are automatically decrypted and retrieved from a local storage of the computer.

If the corresponding data items do not satisfy all of the requested information items, the user is prompted to input one or more missing information items that are not contained within the local storage. A user input of the one or more missing information items is received and the corresponding data items and the one or more missing information items are presented on a display of the computing device. All additional information items are encrypted for later reuse. The information requestor's encryption key is retrieved from the network. An encrypted data submission responsive to the one or more requested information items is transmitted to the information requester.

If the corresponding data items satisfy all of the requested information items, the corresponding data items are presented on a display of the computing device. The encryption key of the information requestor is retrieved from the network. An encrypted data submission of the corresponding data items may then be transmitted to the information requester. A usage policy may be assigned to the data submission by the user before transmitting the data submission to the information requester. The usage policy may apply one or more usage constraints on the requester's use of the one or more requested information items. The one or more usage constraints includes a temporal duration and/or a number of uses.

The computerized system may also be configured to retrieve an encryption key from a server operatively coupled to the network. The data submission may be encrypted with the information-requestor specific encryption key. A confirmation that the data submission has been received by the information requester may also be received by the user. The information request may be a URL, a QR code, a barcode, and a request file.

These and other features, aspects and advantages of the present invention will become better understood with reference to the following drawings, description and claims.

### BRIEF DESCRIPTION OF THE DRAWINGS

FIG. 1 is a representative system architecture for a content exchange network.

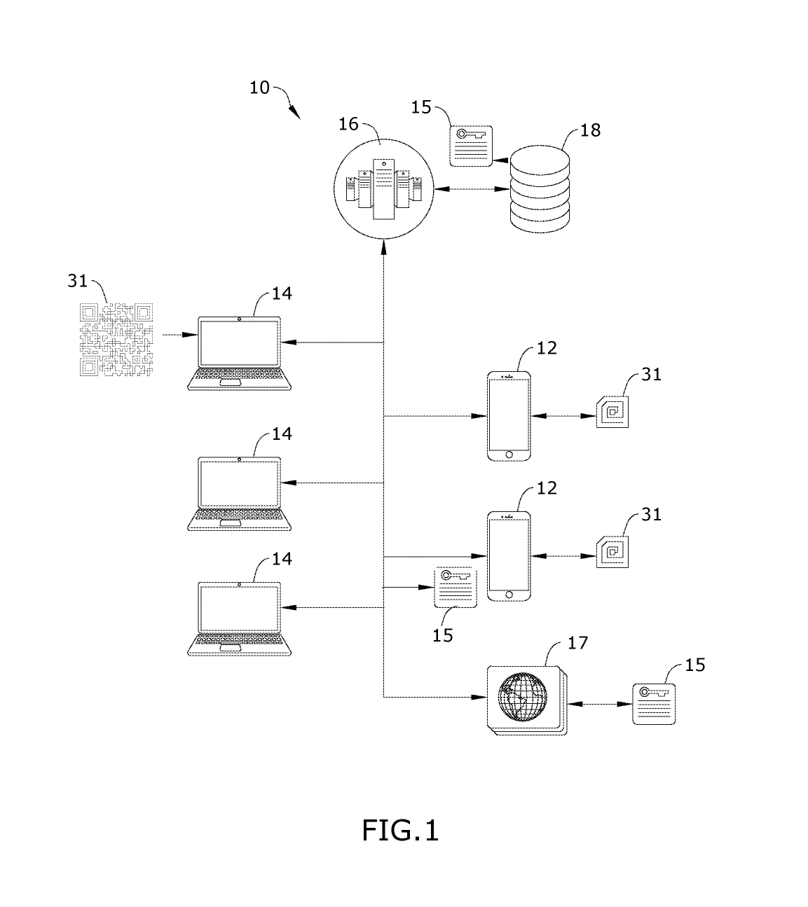

FIG. 2 schematic illustration of a data exchange process according to aspects of the present invention.

FIG. 3 is a flowchart illustrating a method of secure data exchange according to aspects of the invention.

FIG. 4 is a flowchart illustrating an exchange process between a data-owner and an information requestor.

FIG. 5 is a continuation of the flowchart of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved system, method and apparatus for secure exchange of sensitive information over a computer network. By allowing a user to use a combination of mobile and network technologies, controlled user data collection, reuse of entered data, and secure traceable transmission to businesses, the described system can bypass common human security risks and data leaks. In addition, the overall transaction times are substantially lowered while exchanges are standardized. Furthermore, both sides in a transaction will have consistent lifecycle tools to track these exchanges with many consumers and business in a standardized way with more transparent data use.

The current system advantageously eliminates direct human data handling risks while providing control to users on what is exchanged with business systems in a secure and rapid format. It may be utilized to standardize data exchange across many businesses. Data use policies are clearly shown and communicated both ways. The transaction speed is increased through the user being able to reuse commonly submitted data. The system prepares the submissions automatically and only asks the user to fill in unknown data. The user is kept abreast of the receipt of their data by any requesting party.

In one embodiment, the current system can be used to initiate a collection of data from others on the network as well. In such circumstances, it could be used to create completely new digital constructs. In one example, a creative music artist asks his band members to each submit a part of a sound-track and then digitally assemble the parts into an overall new sound recording. A complete history of all collections would be available to all band members. Using life-cycle-tools, they could block the future use of their contribution if there should be a disagreement.

Similar process may be used with other media types such as images and video. For example, a reverse “snap-chat” type application could be built on top of the invention, where users can request “pictures” from other users in their network. These users could provide such pictures and set the use policy to a short time.

In one embodiment, the system comprises a computer network 10 that may connect patients and medical providers. All medical records data is kept with the data owner and stored encrypted in a local memory of the mobile computing device 12. Both the network and device 12 have to properly authenticate for the data-owner to read the data out of the local memory. Medical providers act as information-requester and can make a data request for specific medical information from the data-owner. The data-owner can review the request and release medical records if they agree.

In one embodiment, the system comprises a computer network 10 that connects a mobile computing device 12 of one or more consumers and a computing device 14 of one or more businesses. The system 10 includes a server 16 connected to a secure storage device 18, which may be a network distributed secure storage device 18, and a network software. The mobile computing device 12 may include a tablet with a global positioning system (GPS), and an app (software instructions) downloadable by User to the mobile device with a local storage capability.

The mobile app, which may be called XcooBee is installed on the mobile computing device 12. The XcooBee app translates user inputs, via gestures, such as taps, clicks, swipes, alpha numeric entries and other inputs via a user interface (UI) 20 or one or more controls on the mobile computing device 12. The XcooBee app translates the inputs into commands to be processed by the network server software. The network software can cause data to be stored in the distributed storage 18. The computer network 10 can modify and transport data stored in the distributed storage 18 per instructions and business logic running on the network server 16.

In one embodiment, the user can use the configured mobile computing device 12 to either initiate a data-share or to respond to a data-share request initiated by business 14 through the network server 16. In either case, the mobile device 12 can assist the user with gathering missing information as well as assembling information that is stored in the local storage of the mobile computing device 12 for submission to the server 16 and the network storage device 18. The server 16 is configured to forward the information for storage on the network storage device 16. The business 14 will then receive the information from user via the computer network 10.

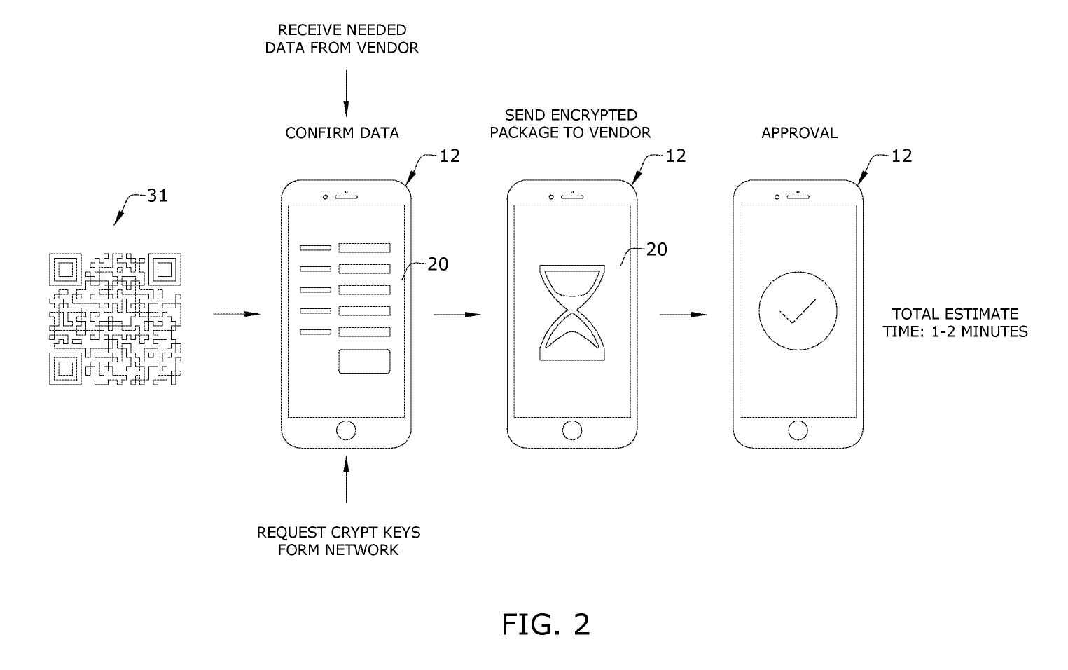

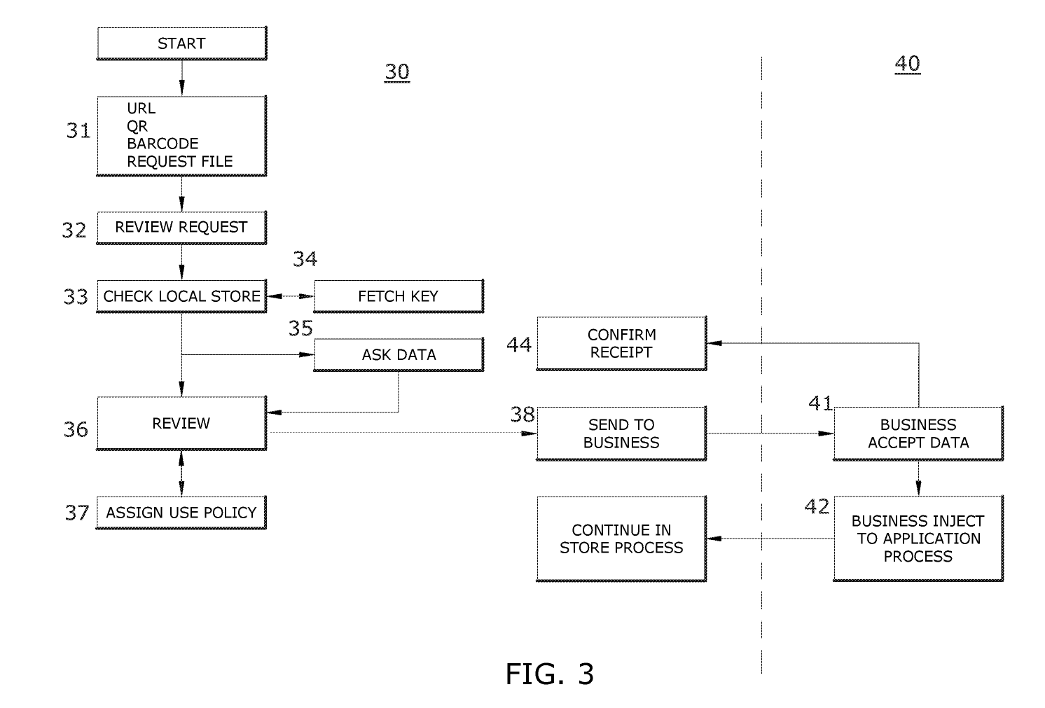

By way of non-limiting example, such as shown in reference to FIG. 2-4, the process may be initiated with a desire to share sensitive data. A data-share request can be initiated by either the consumer (data-owner), normally a user of the mobile computing device 12, or the information-requestor 14 (normally a business) with whom the data-owner wishes to conduct business. In the example shown, a data request 31 may be carried in one or more of a URL, a QR code, a barcode, or a request file. The data request 31 may for example be located proximal to a product or a service that the consumer 12 is interested in acquiring or that a business 14 is promoting. In the case of the QR code, or barcode, the data request may be captured and input to the system by a camera provisioned with the mobile computing device 12.

The data request 31 includes a unique data request ID, one or more requested data items, and one or more condition codes. The data items may include a variety of identifying data elements corresponding to the user, such as name, address, SSN, account information, DOB, and the like.

The data request 31 is translated by the mobile computing device 12 and presented on the user interface 20 so that the user may conduct a preliminary review 32 of the data that is being solicited by the data request 31. If the consumer 12 approves the request, the local storage of the mobile computing device 12 is queried to see if one or more corresponding data items are already resident in the local storage. In preferred embodiments, the corresponding data items are stored in an encrypted form on the local storage device. For secure communication of the data exchange, an encryption key 34 may be fetched from the server 16 for subsequent encryption of the data prior to transmission.

If the app determines that a requested data item is not resident in the local storage, a prompt 35 is presented on the UI to ask the user for the requested data item. The user may then choose whether they want to share that requested data item. If the user determines that they would like to proceed and share the data, a second review 36 of the data request is presented in the UI 20. The second review 36 may contain a listing of each data item that has been gathered to respond to the data request.

Though the business 14 can indicate which data elements it wishes, the user 12 can make a choice on which data-elements are shared. The UI 20 may be configured with a control for the user to assign a use policy 37 to the data request. The use policy 37 may place one or more restrictions on the recipient's use of the data. The use policy 37 restrictions may be a temporal limitation, a limitation on further dissemination with affiliates and related entities, or limited to use only in connection with a specific transaction, or a number of times that the data may be used (one time use, 2× use, etc.). After a final review the user has the choice to send the information securely to the business 14 via the XcooBee computer network 10.

After transmission of the data, the business 14 may accept the data 41. The business acceptance 41 may be configured to provide an automatic response to the user to confirm receipt of the data.

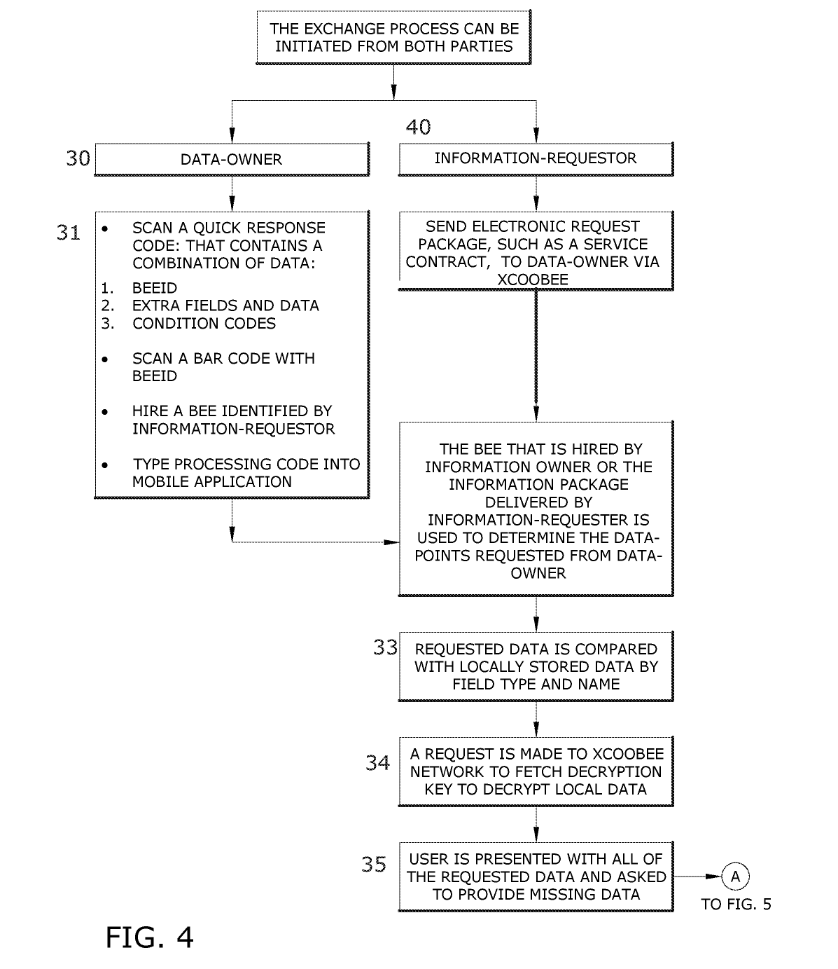

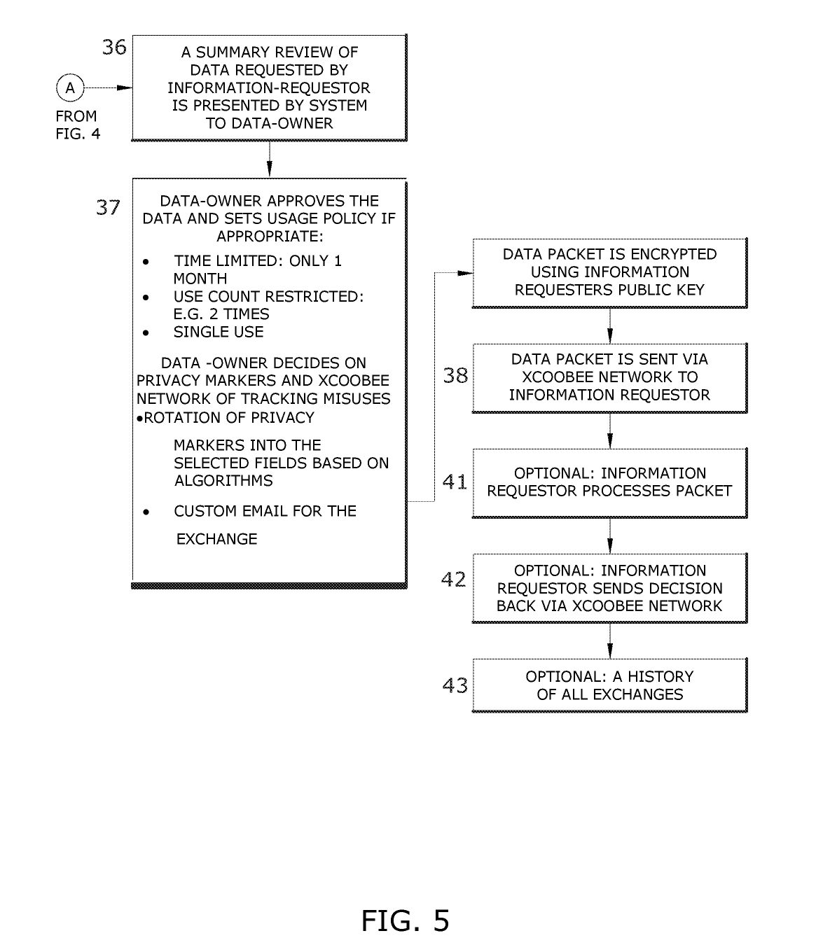

Steps of conducting a representative service contract transaction can be seen in the flowchart of FIG. 4 and the continuation in FIG. 5. In certain embodiments, a standard web interface can used be instead of mobile app. The business and users can connect to the network service via an Application Programming Interface (API) as well. The API can be also be invoked with an SFTP, an SMTP, a Websocket instead of HTTP/S. As indicated earlier, the process can be initiated via printed material such as QR codes and standard bar codes that are captured and processed by a reader on the mobile computing device 12. RFIDs can be used to store the initiation code and invoke the process.

In one embodiment, the user initiates the data-sharing process on the mobile device 12 app (the app), by either scanning a vendor code or entering a published identifier string, or accepting a data-share request. This communicates with the network service 10 to determine the data requested by the vendor 14. The mobile device 12 then, determines whether data is available locally on the device 12. After checking with the network server for encryption keys 15, the app further prompts for any missing data that the business had requested. The app, then, provides a summary review 36, with the requested usage policy from the business. The user reviews the overall submission, changes the data-share policy 37 where needed and submits 38 the data to business via the network service. The user is informed 44 when the business has received and processed the data. The business can, then, reply with any acknowledgement needed back to the user. For example, in case of an electric utility contract, the utility would send the approval 42 and service date/contract back to the user. In case of a credit card application, the acceptance 42 is communicated back to the user via the network server 16 and mobile app while the credit card is shipped via standard mail.

In other embodiments, the system 10 may also standardize the exchange of data while providing insight into data exchanges and life-cycle tools 43. As such it can be used in other areas. For example, it can be used for medical data, for example, health records collected on the mobile device 12 can be exchanged with a health care provider in that fashion. Similarly, a user's insurance card information could be exchanged with their doctor's office. The system may also be used in business-to-business interactions for example when applying for business credit, or exchanging payment information. The “sensitive” data could be any digitized document such as a standard business letter-of-credit, but it could also be a request for a voice-print (recording).

In summary, the invention is a means of initiating and exchanging sensitive information between information-requestors and data-owners in a secure, rapid, and transparent way over a dedicated network. The system eliminates direct human data handling risks while providing control to users on what is exchanged with business systems in a secure and rapid format. The system permits standardization of data exchange across many businesses. Data use policies are clearly shown and communicated both ways. The transaction speed is increased through the user being able to reuse commonly submitted data, and the system preparing submissions automatically and only asking to the user to fill in or provide unknown data. The user is kept abreast of the receipt of their data by any requesting party. Everyone has access to life-cycle tools 43 to recall events, dates, and data.

It should be understood, of course, that the foregoing relates to exemplary embodiments of the invention and that modifications may be made without departing from the spirit and scope of the invention as set forth in the following claims.

As indicated, the system of the present invention may include at least one computer 12, 14 with a user interface 20. The computer 12 may include any computer including, but not limited to, a desktop 14, a laptop 14, and smart device 12, such as, a tablet and smart phone. The computer includes a program product including a machine-readable program code for causing, when executed, the computer to perform steps. The program product may include software which may either be loaded onto the computer 12 or accessed by the computer 12. The loaded software may include an application on a smart device . The software may be accessed by the computer using a web browser 17. The computer may access the software via the web browser using the internet, extranet, intranet, host server 16, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail.

It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-readable memory adapted for use by a user of a data sharing client application to exchange sensitive data over a network, the computer-readable memory used to direct a computer on the network to perform the steps of:
receiving a data request from an information requester on the network platform, the data request seeking one or more requested information items from the user of the data sharing client;
presenting the requested information items in a display of the computer;
automatically retrieving, from a local storage of the computer, one or more corresponding data items matching the one or more requested information items;
determining if the corresponding data items satisfy all of the requested information items, if the corresponding data items do not satisfy all of the requested information items;
prompting the user to input one or more missing information items that are not contained within the local storage;
receiving a user input of the one or more missing information items;
presenting the corresponding data items and the one or more missing information items on a display of the computing device;
transmitting a data submission responsive to the one or more requested information items to the information requester via the network platform;
if the corresponding data items satisfy all of the requested information items;
presenting the corresponding data items on a display of the computing device; and
transmitting a data submission of the corresponding data items to the information requester via the network platform.

2. The computer-readable memory of claim 1, further comprising:
assigning a usage policy to the data submission, by the user, before transmitting the data submission to the information requester.

3. The computer-readable memory of claim 2, wherein the usage policy applies one or more usage constraints on the requester's use of data submission.

4. The computer-readable memory of claim 3, wherein the one or more usage constraints includes a temporal duration, a number of uses.

5. The computer-readable memory of claim 1, further comprising:
retrieving an encryption key from a server operatively coupled to the network.

6. The computer-readable memory of claim 5, further comprising:
encrypting the data submission with the encryption key.

7. The computer-readable memory of claim 1, further comprising:
receiving a confirmation that the data submission has been received by the information requester.

8. The computer-readable memory of claim 1, wherein the information request is selected from the group consisting of a URL, a QR code, a barcode, and a request file.

9. The computer readable memory of claim 1, wherein the one or more corresponding data items are stored in an encrypted form on the local storage.

10. A computerized system for use by a user of a data sharing client application to exchange sensitive data over a network platform, the system comprising:
a computer having a user interface; and
a program product comprising machine-readable program code for causing, when executed, the computer to perform the following process steps:
receiving a data request from an information requester on the network platform, the data request seeking one or more requested information items from the user of the data sharing client;
presenting the requested information items in a display of the computer;
automatically retrieving, from a local storage of the computer, one or more corresponding data items matching the one or more requested information items;
determining if the corresponding data items satisfy all of the requested information items,
if the corresponding data items do not satisfy all of the requested information items;
prompting the user to input one or more missing information items that are not contained within the local storage;
receiving a user input of the one or more missing information items;
presenting the corresponding data items and the one or more missing information items on a display of the computing device; and
transmitting a data submission responsive to the one or more requested information items to the information requester;
if the corresponding data items satisfy all of the requested information items;
presenting the corresponding data items on a display of the computing device; and
transmitting a data submission of the corresponding data items to the information requester.

11. The computerized system of claim 10, further comprising:
assigning a usage policy to the data submission, by the user, before transmitting the data submission to the information requester.

12. The computerized system of claim 11, wherein the usage policy applies one or more usage constraints on the requester's use of the one or more requested information items.

13. The computerized system of claim 12, wherein the one or more usage constraints includes a temporal duration, a number of uses.

14. The computerized system of claim 10, further comprising:
retrieving an encryption key from a server operatively coupled to the network.

15. The computerized system of claim 14, further comprising:
encrypting the data submission with the encryption key.

16. The computerized system of claim 10, further comprising:
receiving a confirmation that the data submission has been received by the information requester.

17. The computerized system of claim 10, wherein the information request is selected from the group consisting of a URL, a QR code, a barcode, and a request file.

18. The computerized system of claim 10, wherein the one or more corresponding data items are stored in an encrypted form on the local storage.
